(19) United States
(12) Patent Application Publication
(10) Pub. No.: US 2011/0083787 A1
(43) Pub. Date: Apr. 14, 2011

(54) METHOD OF IMPULSE WELDING NON-WATERPROOF, DIGITALLY PRINTABLE FABRICS

(75) Inventor: Brian D. Henry, North Lawrence, OH (US)

(73) Assignee: MILLER WELDMASTER CORPORATION, Navarre, OH (US)

(21) Appl. No.: 12/577,606

(22) Filed: Oct. 12, 2009

(51) Int. Cl. B29C 65/30; B29C 65/02; B32B 38/00; B32B 38/04

(52) U.S. Cl. 156/64; 156/306.6; 156/256; 156/273.7

(57) ABSTRACT

A method of impulse welding a first and a second fabric panel together. The method includes positioning a sealing tape between the panels, applying heat and pressure to the same, followed immediately by applying cold and pressure to the same. The first and second fabric panels are fabrics that are non-waterproof and are either digitally printed or digitally printable. The sealing tape is a tape that melts into and bonds the fabric panels together.

### BACKGROUND OF THE INVENTION

1. Technical Field

The present invention relates generally to the joining of layers of sheet material. More particularly, the present invention relates to a method of heat welding sheet materials together. Specifically, the present invention is directed to a method of heat welding non-waterproof, digitally printable fabrics.

2. Background Information

Heat welding has long been used to join waterproof sheet materials together to manufacture a variety of products such as tents, tarpaulins, and liners for pools and landfills. During the manufacturing process, two pieces of a waterproof sheet material are overlapped and a combination of heat and pressure is applied to the overlapped region to weld the materials together and create a seam. This procedure permits longer pieces of the waterproof sheet materials to be produced so that the end product can be manufactured out of the same.

Various techniques have been developed to join sheet materials of this nature together. These include hot air welding, hot wedge welding and impulse welding. In hot air welding a nozzle is positioned so as to blow heated air between the two layers of sheet material. Typically, for a thermoplastic sheet material, the temperatures involved range between 200 F to 1,350F (90 C to 750 C). Once the heat has been introduced between the layers, a roller passes over the same, applying a preset level of pressure to the layers. The combination of the heat and pressure joins the materials together. Hot air welding requires precise temperatures and pressure to be applied to the sheet materials and also requires that the process be done in a timely fashion in order to prevent cooling of the sheet materials before the roller passes over the same. If the temperature or pressure is off, the weld will not be complete and the materials may separate from each other.

Hot wedge welding is fairly similar to hot air welding, with the exception that instead of a nozzle being used to introduce heat into the system, a heated wedge is used. The wedge is positioned so that the fabric layers are pulled over the wedge immediately before they are contacted by the rollers. Wedges are typically heated to a temperature of between 200 F to 920 F (90 C to 490 C). Once again, the temperature, pressure and time have to be closely monitored in order to create a good seam.

Impulse welding involves positioning the overlapped region of the sheet material layers between two spaced apart bars and then moving at least one of the bars so that the overlapped region is clamped between them. Once the sheet material is correctly positioned, one or both of the bars are heated up to the sheet material's melting point by an electrical impulse of short duration. The bars are then cooled while the sheet material is still under pressure. This procedure creates a good, strong, and flat seam. Typically, the bars in impulse welders will be used on fabrics that have a melt index of less than around 700° F.

All of these above-described techniques rely on the nature of the sheet materials themselves to aid in creating a bond between the overlapped layers. Typically, the type of sheet material used in these applications is a material that is readily heated and at least partially melted by the hot air, hot wedge or heated bar. Pressure is applied after the heating step to compress the partially melted thermoplastic layers together.

These techniques are typically not used to create seams in non-waterproof. Instead, the usual manner of creating seams is through sewing or gluing the overlapped two layers together. This is a time-consuming procedure. Obayashi et al. in U.S. Pat. No. 4,410,575 addressed this issue by proposing the joining of lengths of textile fabrics through lap welding. In this process, a thermally melting, synthetic polymeric bonding tape is positioned between two overlapped lengths of textile fabric. A high frequency wave treatment or heat treatment is then applied to the bonding tape, particularly the region that is interposed between the two fabrics. Pressure is then applied to the overlapped region to weld the layers together. Preferably, the entire width of the tape is covered over by the overlapped materials so that there is a region of the tape that extends for a short distance over the fabric. This region of tape is not melted during the bonding process and apparently aids in preventing the textile fabrics from separating from each other. After the heat and pressure have been applied to the overlapped region, the welded fabrics are then allowed to stand and cool to set the melted polymeric material. The patent discloses the preferential use of an adhesive either on the tape or fabric to hold the same in place prior to application of heat to the overlapped region.

One of the fields in which is it desirable and necessary to utilize relatively large fabric sheets is in the creation of articles such as signs, banners, theatrical backdrops, billboard advertisements, and the like. Recently, it has become possible to digitally print photo-quality images onto fabrics instead of using the much slower and more expensive technique of screen printing. Utilizing digital printing in the production of articles such as banners, signs and advertisements would increase the quality and speed of production and would greatly reduce the cost of these articles. There is, however, a problem in using this technique. That problem is that the types of fabrics that can most easily be utilized for digital printing tend to be non-waterproof and do not easily melt upon application of heat thereto. This means that the large fabric sheets have to be made using smaller panels of fabric that must be sewn or glued together.

There is therefore a need in the art for an improved method of producing large sheets of non-waterproof, digitally printable or digitally printed fabric from a plurality of smaller panels of the same.

### BRIEF SUMMARY OF THE INVENTION

The present invention comprises a method of impulse welding a first and a second fabric panel together. The method includes positioning a sealing tape between an overlapped zone of the panels and then applying heat and pressure to the same, followed immediately by applying cold and pressure to the overlapped zone. The first and second fabric panels are fabrics that are non- waterproof and are either digitally printed or digitally printable. The sealing tape is a tape that melts into and bonds the fabric panels together.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a side view of a welding machine used to impulse weld panels of digitally printable fabric together;

FIG. 2 is an enlarged side view of the highlighted region of FIG. 1, showing the end regions of the two fabric panels with a heat sealing tape disposed between them and two impulse welding bars positioned to heat-weld the fabrics together;

FIG. 3 is an enlarged side view of the welding bars applying pressure to the overlapped region of the fabric panels;

FIG. 4 is a cross-sectional side view through a first embodiment of a seam formed between a first and a second digitally printed fabric panel using impulse welding;

FIG. 4a is a perspective view of a banner produced by joining several panels of digitally printed fabric together;

FIG. 5 is a cross-sectional side view through the overlap seam formed by the method illustrated in FIGS. 1-4a;

FIG. 6 is a cross-sectional side view through a second embodiment of a seam formed by impulse welding digitally printed fabric panels;

FIG. 7 is a cross-sectional side view through a third embodiment of a seam formed by impulse welding digitally printed fabric panels;

FIG. 8 is a cross-sectional side view through a fourth embodiment of a seam formed by impulse welding digitally printed fabric panels;

FIG. 9 is a cross-sectional side view through a fifth embodiment of a seam formed by impulse welding digitally printed fabric panels; and

FIG. 10 is a cross-sectional side view through a sixth embodiment of a seam formed by impulse welding digitally printed fabric panels.

Similar numbers refer to similar parts throughout the drawings.

### DETAILED DESCRIPTION OF THE INVENTION

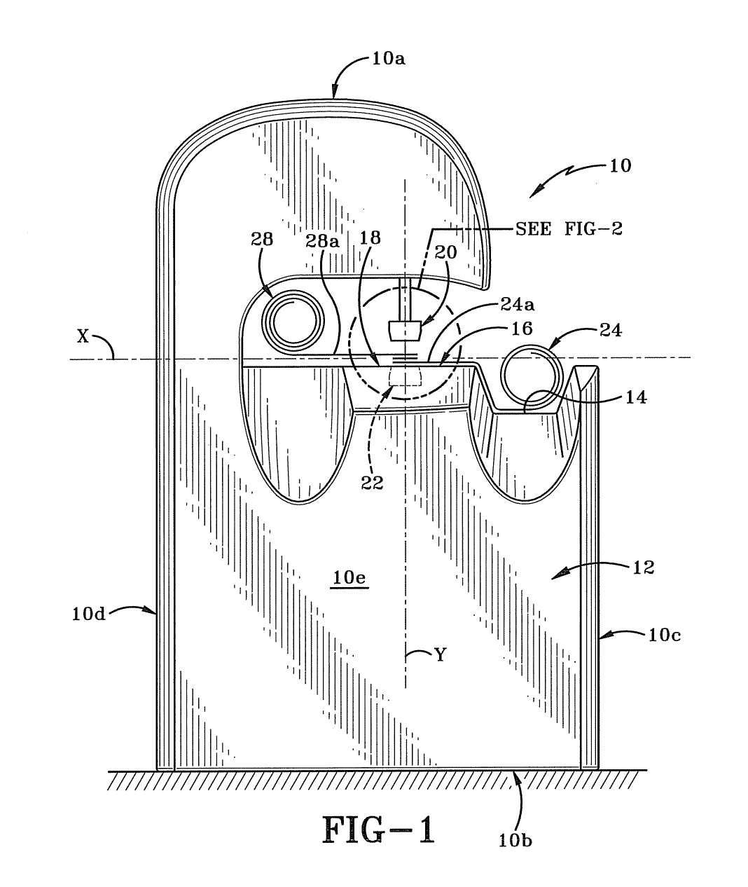

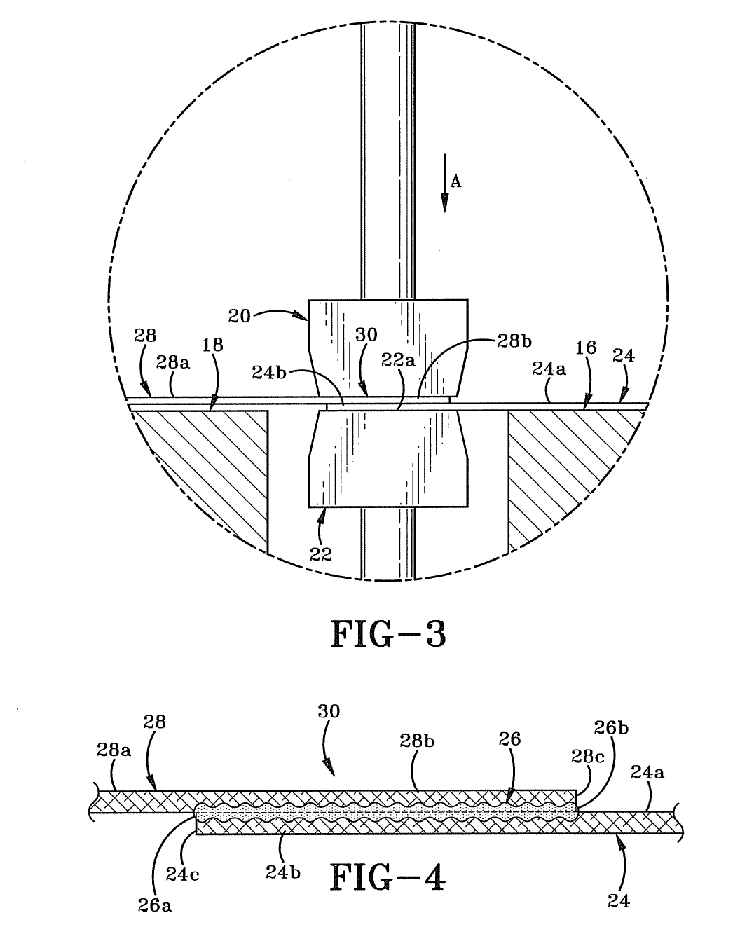

Referring to FIGS. 1-4a there is shown a welding machine 10 used to join a first fabric panel to a second fabric panel. It should be understood that the word “fabric” as used in this specification is intended to describe textiles and textile-like materials and films that are relatively thin and flexible in nature.

Welding machine 10 comprises a frame 12 including a front handling trough 14, a front material table 16, and a rear material table 18. In describing the present invention, it may be advantageous to first define longitudinal, lateral, and vertical directions positioned to be substantially mutually orthogonal. The vertical axis “Y” (FIG. 1) extends from the top 10a of the machine 10 to the bottom 10b thereof. The lateral axis “X” extends from the front 10c of the machine to the back 10d thereof. The longitudinal axis is not shown in these figures but it extends from one side 10e of the machine 10 to the other side thereof.

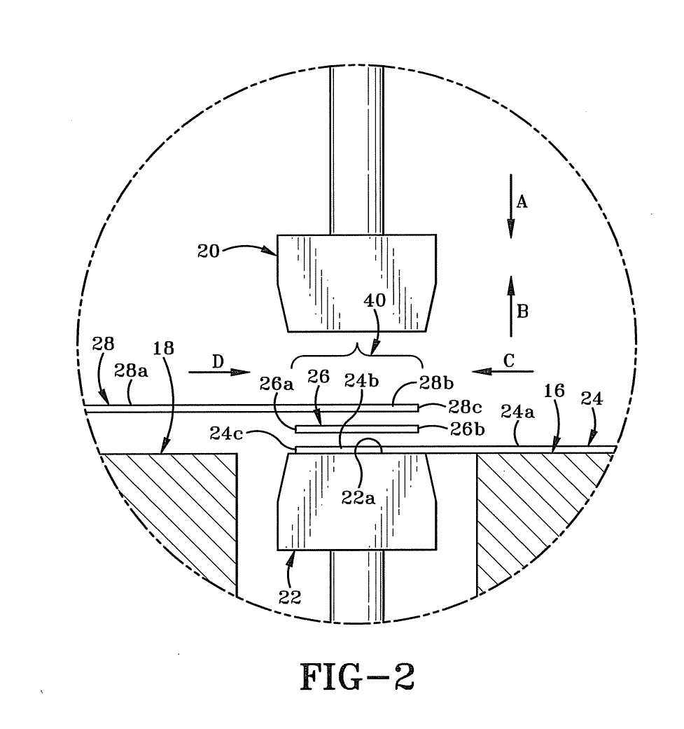

An upper welding bar 20 and a lower welding bar 22 are mounted on frame 12. Upper bar 20 is mounted on frame 12 by a plurality of hydraulic or pneumatic cylinders for reciprocal movement in a direction parallel to vertical axis “Y”. Upper bar 20 is therefore able to be moved downwardly in the direction of arrow “A” (FIG. 2) and toward lower bar 22 and to move upwardly in the direction of arrow “B” away from lower bar 22. Upper bar 20 is also able to apply pressure in the direction of arrow “A” to lower bar 22. It will be understood that instead of upper bar 20 moving toward and away from lower bar 22 and applying pressure thereto, lower bar 22 may, instead, be mounted for movement toward and away from upper bar 20 and to apply pressure thereto. Still further, both bars 20, 22 may be mounted on frame 12 so that they may be moved toward and away from each other and apply pressure to fabrics that are positioned between them.

Although not illustrated in these figures, it should be understood that both of the bars 20 and 22 are elongate members that extend longitudinally for substantially the entire length of the machine 10. Utilizing bars of around 3 m in length has been found to be suitable for most impulse welding operations. At least one, but preferably both bars 20, 22 are able to be rapidly heated and rapidly cooled upon being activated. Thus, one or both bars 20, 22 are provided with a heating element (not shown) connected to an electric power source (not shown). When activated, energy is pulsed through the bar to even heat the entire length of the bar 20, 22 to a temperature of around 700° F. Furthermore, one or both bars 20, 22 are provided with a liquid cooling system (not shown) for rapid cooling of the same to a temperature of around 100° F.

Machine 10 further includes a digital control panel (not shown) that may be utilized to enter the temperature settings for the upper and lower bars 20, 22. The control panel is also used to set the pressure and timer settings prior to activating the machine. The digital control of these parameters enables the operator to consistently produce strong welds.

Machine 10 is utilized in the following way to weld two lengths of fabric together. Preferably, and in accordance with the present invention, the first step in the process is selecting a first fabric panel 24 from a group of fabrics that are one or more of non-waterproof, digitally printable and digitally printed fabrics. More specifically, first fabric panel 24 should be a fabric that does not melt upon application of heat thereto and has had a layer of ink digitally applied to an upper surface 24a thereof during a digital printing procedure or is capable of having a layer of ink digitally applied to its upper surface. The ink is applied or will be applied in a pattern that will ultimately form a first section 25 of a design 23 (FIG. 4a) on the article 27 that is being produced. Suitable fabric materials for selection as the first fabric panel include 100% polyester fabrics such as SolvoTex (™) Artist Premium Light S, manufactured by Neschen Americas of Elkridge, Md.

The next step in the process is selection of a second fabric panel 28 to be joined or welded to the first fabric panel 24. The second fabric panel 28 may be an identical fabric to the first fabric panel 24 or may differ therefrom. The selection of second fabric panel 28 is made from a group of fabrics that are one or more of non-waterproof, digitally printable and digitally printed fabrics. As with the first fabric panel, a suitable material for the second fabric panel 28 is polyester. Preferably, the selected fabric should not melt upon application of heat thereto and has had a layer of ink digitally applied to an upper surface 28a thereof during a digital printing procedure or is capable of having a layer of ink digitally applied to its upper surface. The ink is applied in a pattern that will ultimately form a second section 29 of the design 23 (FIG. 4a) on the article 27.

Once the first and second fabric panels 24, 28 are selected, the panels 24, 28 are placed on the machine for joining. First fabric panel 24 is placed in front handling trough 14 of machine 10. This first fabric panel 24 is illustrated as rolled up and retained in front handling trough 14 but it will be understood that the length of the fabric may be too long to do this and the majority of the fabric may therefore be placed on the ground adjacent front 10c of machine 10. Second fabric panel 28 is positioned on rear material table 18. Alternatively, the length of the second fabric panel 28 may be too long and the majority of the fabric may therefore be retained on the floor adjacent the back 10d of machine 10.

Once the first and second fabric panels 24, 28 are in place on the front and rear material tables 16, 18, the operator pulls a length of first fabric panel 24 laterally across front material table 16 and toward lower welding bar 22 in a direction “C”. This movement continues until the lower surface of first region 24b of first fabric panel 24 is positioned in abutting contact with the upper surface 22a of lower welding block 22. Machine 10 may be provided with a laser alignment device (not shown) to indicate to the operator where to laterally position the edge 24c of first fabric panel 24. The operator will therefore position the edge 24c of first fabric panel 24 in line with the laser emitted by the alignment device in order to correctly position the first region.

A length of sealing tape 26 is then pulled longitudinally across the upper surface 24a of the first region 24b of first fabric panel 24 and is positioned adjacent that upper surface 24a. The side edge 26a of sealing tape 26 preferably is aligned with the edge 24c of first fabric panel 24. Sealing tape 26 may be any suitable acrylic, polyurethane or polyester tape that will melt when heated. Preferably, sealing tape 26 is a tape that is 0.008 inches thick and 0.875 inches wide, and has a melting point in the range of 200° F. to 700° F.

In order to simplify the placement of sealing tape 26, welding machine 10 may be provided with a sealing tape dispenser (not shown) that is located proximate one of the sides of machine 10, such as side 10e, The dispenser preferably would be longitudinally aligned with lower bar 22. If such a dispenser is provided, the operator will pull a length of the sealing tape 26 from the dispenser and will position the same longitudinally adjacent the first region 24b of first fabric panel 24. A cutter (not shown) may be used to transversely detach that length of sealing tape from the roll.

The operator then pulls a length of second fabric panel 28 laterally across rear material table 18 in a direction “D” until the second region 28b thereof is positioned vertically adjacent the upper surface of tape 26. Once again, an optical device may be utilized to indicate to the operator if the correct location has been found for the edge 28c of second fabric 28. Preferably, the edge 28c is aligned with the side edge 26b of sealing tape. Thus, an overlapped zone 40 is created as illustrated in FIG. 2 is shown. Preferably, as shown in FIG. 2, the edges 24c and 28c of first and second fabric panels 24, 28 in overlapped zone 40 are aligned with the sides 26a, 26b of tape 26. It will be understood, however, that the sides 26a, 26b of tape 26 may be disposed inwardly or outwardly of the edges 24c, 28c of first and second panels 24, 28 without departing from the spirit of the present invention.

The operator then enters the temperature, pressure, and time settings into the control panel and activates machine 10 to impulse weld the overlapped zone 40 of first and second fabric panels 24, 28 together. Activation causes upper welding bar 20 to be moved vertically downwardly in the direction of arrow “A” until it contacts the upper surface 28a of second fabric panel 28 and pushes the same downwardly. The overlapped zone 40 of first and second fabric panels 24, 28 and sealing tape 26 are thereby clamped between upper and lower welding bars 20, 22 and pressure is applied thereto. At least one and preferably both of upper and lower bars 20, 22 are heated along their entire lengths by pulses of energy moving along the heating element (not shown) in the bars 20, 22. The heat melts the sealing tape 26 and the melted material is absorbed by the first and second regions 24b, 28b of the first and second fabric panels 24, 28. This is illustrated in FIG. 4.

After the duration of a suitable period of time, such as ten seconds, the heating cycle is shut off in the bars 20, 22 and the cooling cycle is initiated. In this cooling cycle, the surfaces of the bars 20, 22 in contact with first and second fabric panels 24, 28 are rapidly cooled, thereby extracting heat from the overlapped zone 40. This causes the creation of a strong flat seam 30 (FIG. 4a) in the overlapped zone 40. The seam 30 securely connects the first and second fabric panels 24, 28 together. The seam 30 is strong and because the sealing tape has melted and been absorbed by the fabric in the overlapped zone 40, the first and second fabric panels 24, 28 cannot be easily separated from each other even if opposing forces act on the seam 30.

Additional panels 32, 34 of digitally printed fabric may be joined in like manner to the connected first and second panels 24, 28 to create the article 27 that is of the desired length. These additional panels 32, 34 may also include ink that has been digitally laid over the upper surface of the fabric to form additional sections 31, 33, respectively, of the overall design 23 on the article 27.

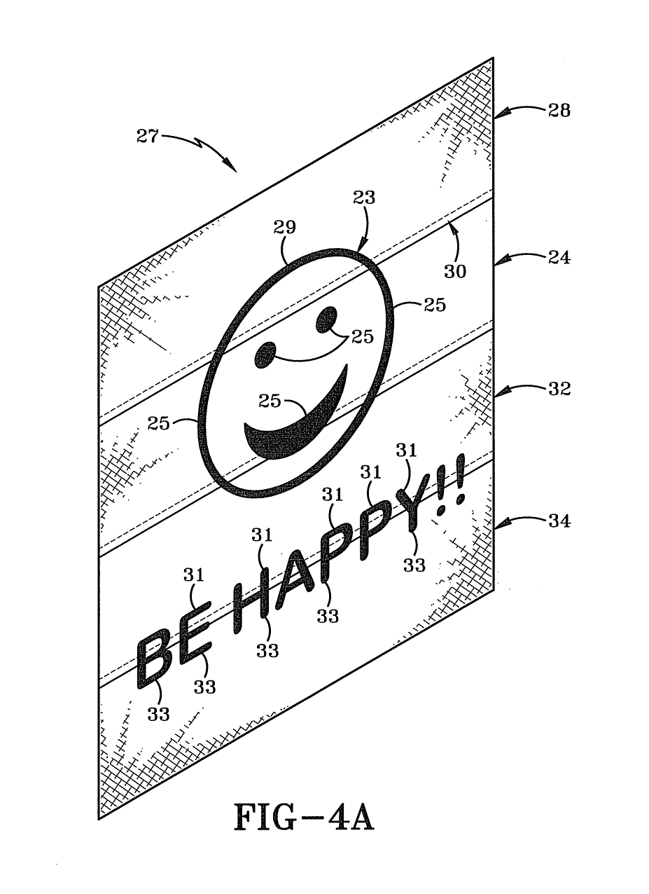

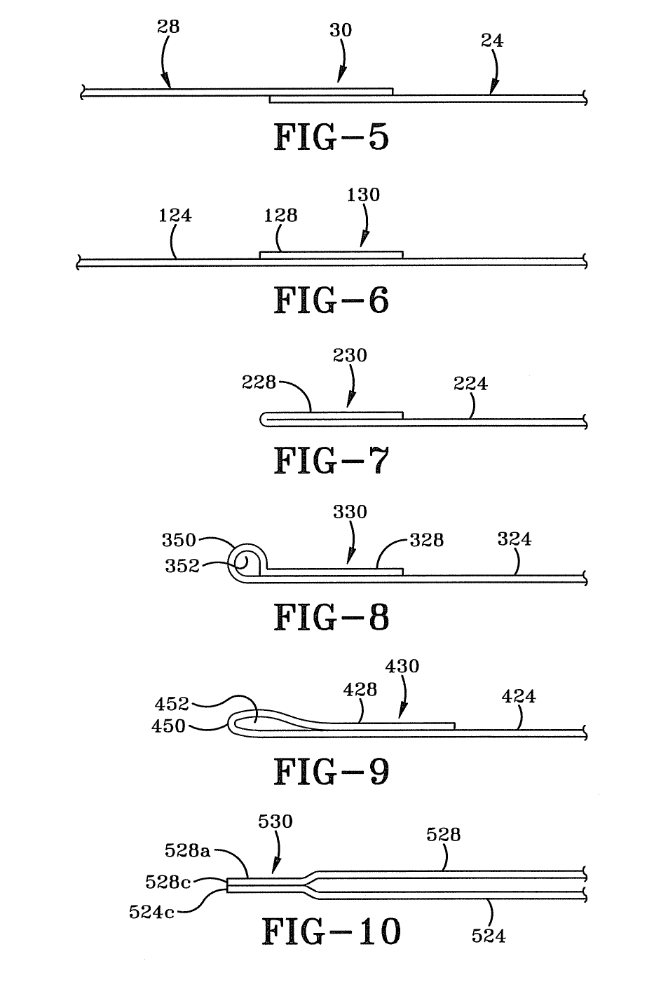

FIGS. 5 through 10 illustrate a variety of different seam types that may be formed by impulse welding panels of digitally printed fabrics together. In all of these examples, the sealing tape has been melted and absorbed into the fabric and therefore is not shown in the drawings.

FIG. 5 illustrates the first embodiment of a seam that has been previously described herein. This type of seam 30 is referred to as an overlap seam.

FIG. 6 illustrates a second embodiment of a seam that may be produced by impulse welding digitally printed fabrics. The seam, indicated at 130 is a webbing reinforcement provided to strengthen a particular region of a first fabric panel 124. The sealing tape (not shown) is positioned between a second panel 128 and the region of the first fabric panel 124 requiring strengthening prior to engagement by the upper welding bar.

FIG. 7 illustrates a hem 230. In this instance, a length of fabric is folded back on itself to form a lower first fabric panel 224 and an upper second fabric panel 228 connected together along a longitudinally aligned fold 250. The sealing tape is inserted between first and second fabric panels 224, 228 in such a manner that a longitudinal side edge of the tape butts up against the fold 250. The seam 230 is formed by impulse welding the overlapped zone that extends for substantially the entire length and width of the second fabric panel 228.

FIG. 8 illustrates a type of seam or seal 330 known as a hem with rope 330. This seam is formed in much the same manner as with the hem 230 except that the longitudinal side edge of the sealing tape is spaced a distance inwardly away from the fold 350 and does not butt up against the same. Additionally, only the overlapped zone that includes the first fabric panel 324, the second fabric panel 328 and the sealing tape is heat welded together. The circular pocket 352 is a region of the fabric that is not heated and placed under pressure. Even if it were, because no sealing tape is located in this region of the fabric, the first and second fabric panels will not be joined to each other. It will be understood that beading or the like may be placed in this pocket prior to impulse welding or may be threaded through the pocket after welding has been completed.

FIG. 9 illustrates a hem 430 with a pocket. This is formed in substantially the same manner as the version in FIG. 8 except the pocket 452 is longer and shallower. Again, the fabric is folded back on itself to form the first fabric panel 424 and second fabric panel 428 joined longitudinally by a fold 450. The longitudinal side edge of the sealing tape is positioned a distance inwardly away from the fold 450. Once again, the overlapped zone that becomes seam 430 is heat welded and the pocket region 452 is not. However, even it if is contacted by the welding bars, the fabric used in the pocket 452 cannot bond together without the sealing tape. This type of pocket 452 would be suitable for receiving a planar support for hanging the article being manufactured.

FIG. 10 illustrates a fin seal 530. Here a second fabric panel 528 is adjacent the first fabric panel 524 in such a manner that the longitudinal edge 528c of the second fabric panel 528 is vertically aligned with the longitudinal edge 524c of the first fabric panel 524. The sealing tape is positioned between the two layers with the longitudinal side edge of the sealing tape vertically aligned with the edges 528c, 524c prior to application of impulse welding to the overlapped zone.

It will be understood that a wide variety of other types of seams, seals and reinforcements can be produced utilizing this method. Additionally, it should be understood that more than two fabric panels can be joined together utilizing this method. So, for example, if it is necessary, a third fabric panel (not shown) may be joined to the first and second fabric panels 524, 528 illustrated in FIG. 10. This would be accomplished by positioning an additional layer of sealing tape (not shown) adjacent the upper surface 528a of second fabric panel 528 proximate the edge 528c thereof, positioning the third fabric panel thereover so that the edge of the third fabric panel is aligned with the edges 528c and 524c, and then clamping the overlapped zone between the upper and lower welding bars.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A method of welding a first fabric panel to a second fabric panel comprising the steps of:
selecting the first fabric panel;
selecting the second fabric panel; wherein one or both of the first and second fabric panels are selected from fabrics that are one of non-waterproof, digital printable and digitally printed;
positioning the first fabric panel so a first region thereof is disposed between an upper welding bar and a lower welding bar of an impulse welding machine;
positioning a length of a sealing tape adjacent the first region, such that a lower surface of the tape is adjacent an upper surface of the first region;
positioning a second region of the second fabric panel between the upper and lower welding bars such that a lower surface of the second region is adjacent an upper surface of the sealing tape, said first and second regions and the sealing tape forming an overlapped zone;
vertically moving one or both of the upper and lower welding bars so as to clamp the overlapped zone thereinbetween;
applying pressure to the overlapped zone via one or both of the upper and lower welding bars;
heating one or both of the upper and lower welding bars for a first time period while pressure is applied to the overlapped region;
cooling one or both of the upper and lower welding bars for a second time period after the first time period has elapsed and while pressure is applied to the overlapped zone;
vertically moving one or both of the upper and lower welding bars so as to release the overlapped zone;
removing the connected first and second fabric panels from the machine.

2. The method as defined in claim 1, wherein the steps of selecting one or both of the first and second fabric panels comprise selecting a fabric that is non- waterproof and one of digitally printable and digitally printed.

3. The method as defined in claim 1, wherein the steps of selecting the first and second fabric panels include selecting one or both of the first and second fabric panels from a group of digitally printed and digitally printable fabrics that do not tend to melt upon application of heat thereto.

4. The method as defined in claim 1, wherein the step of selecting the first and second fabric panels includes selecting a polyester fabric.

5. The method as defined in claim 1, wherein the step of selecting the first and second panels includes selecting first and second panels that are made from the same fabric.

6. The method as defined in claim 1, wherein the step of selecting the first and second panels includes selecting first and second panels that are made from different fabrics.

7. The method as defined in claim 1, wherein the step of positioning the first fabric panel comprises moving the first fabric panel laterally and rearwardly across a front material tray until the lower surface of the first fabric panel abuts the lower welding bar.

8. The method as defined in claim 7, further comprising the step of visually aligning a longitudinal free edge of the first fabric panel with a longitudinally aligned laser light beam.

9. The method as defined in claim 1, wherein the step of positioning a length of sealing tape includes pulling the sealing tape longitudinally across the upper surface of the first fabric panel.

10. The method as defined in claim 9, wherein the step of pulling the sealing tape across the first fabric panel includes the steps of:
dispensing the length of sealing tape from a tape dispenser disposed proximate a first side of the welding machine;
pulling the tape across the first fabric panel until an end of the tape is disposed proximate a first side edge of the first fabric panel which is disposed proximate a second side of the welding machine;
moving a cutter element laterally across the sealing tape proximate a second side edge of the first fabric panel to cut the length of sealing tape free of the dispenser.

11. The method as defined in claim 10, wherein the step of positioning the second fabric panel comprises moving the second fabric panel laterally and forwardly across a rear material tray until the lower surface of the second fabric panel is disposed adjacent the upper surface of the sealing tape.

12. The method as defined in claim 1, wherein the step of heating one or both of the upper and lower welding bars includes the step of passing an electric current through a heating element in the one or both of the upper and lower welding bars for the first period of time.

13. The method as defined in claim 1, wherein the step of cooling one or both of the upper and lower welding bars includes the step of circulating a cooling liquid through a cooling system in the one or both of the upper and lower welding bars for a second period of time.

14. The method as defined in claim 13, wherein the step of cooling occurs is immediately after the step of heating.

15. The method as defined in claim 1, further comprising the steps of:
entering pressure and temperature settings into a control panel on the welding machine; and
activating the welding machine via the control panel in order to move the one or both of the upper and lower welding bars.

16. The method as defined in claim 1, wherein the steps of heating and cooling one or both of the upper and lower bars include heating and cooling one or both of the upper and lower bars along substantially their entire length.

17. The method as defined in claim 1, wherein the step of positioning the first and second fabric panels includes the step of folding a portion of a length of fabric back upon itself so that a lower region of the length of fabric comprises the first fabric panel and an upper region of the length of fabric comprises the second fabric panel, and the first and second fabric panels are longitudinally connected to each other along a fold.

18. The method as defined in claim 17, wherein the step of positioning the sealing tape includes butting a longitudinal side edge of the sealing tape against the fold.

19. The method as defined in claim 18, wherein the step of positioning the sealing tape includes spacing a longitudinal side edge of the sealing tape a distance inwardly away from the fold.

20. The method as defined in claim 1, wherein the steps of positioning the first and second fabric panels include aligning a longitudinal free edge of the first fabric panel with a longitudinal free edge of the second fabric panel; and the step of positioning the sealing tape includes aligning a longitudinal side edge of the sealing tape with the aligned free edges of the first and second fabric panels.

21. The method as defined in claim 1, further comprising the step of selecting a sealing tape from a group of tapes including acrylic tapes, polyurethane tapes and polyester tapes.
